(19) United States
(12) Patent Application Publication
(10) Pub. No.: US 2010/0161696 A1
(43) Pub. Date: Jun. 24, 2010

(54) RANDOM NUMBER GENERATOR AND PSEUDO-RANDOM NUMBER GENERATOR

(75) Inventor: Akihiro Matsui, Tokyo (JP)

Correspondence Address: SPRINKLE IP LAW GROUP, 1301 W. 25TH STREET, SUITE 408, AUSTIN, TX, 78705, US

(73) Assignee: Kabushiki Kaisha Toshiba, Tokyo (JP)

(21) Appl. No.: 12/613,685

(22) Filed: Nov. 6, 2009

(30) Foreign Application Priority Data
Dec. 15, 2008 (JP) 2008-318666

(51) Int. Cl. G06F 7/58; G06F 5/01

(52) U.S. Cl. 708/209; 708/255; 708/254

(57) ABSTRACT

A random number generator which includes a bus including a plurality of bus lines configured to send and receive a signal between a circuit and another circuit, a calibration unit configured to dynamically adjust a reception condition of the signal, and a random number generating unit configured to generate a random number based on adjustment information of the calibration unit.

### CROSS REFERENCE TO RELATED APPLICATION

This application claims the benefit of Japanese Application No. 2008-318666 filed in Japan on Dec. 15, 2008, the contents of which are incorporated herein by this reference.

### BACKGROUND OF THE INVENTION

1. Field of the Invention

The present invention relates to a random number generator and a pseudo-random number generator, and particularly to a random number generator which generates a random number based on a variation of a reception condition of a signal received via a bus, and a pseudo-random number generator using such a random number as a seed.

2. Description of the Related Art

Encryption technologies have been widely used because of increase of awareness of security. Random numbers are required in many encryption technologies. As a method for easily obtaining a random number, a pseudo-random number generator is generally used. Since a pseudo-random number is a number contained in a number sequence obtained by a deterministic calculation, if the same value, that is, the same seed is inputted for execution, the same random number is generated. Therefore, what type of value to use as a seed is important for pseudo-random number generators. For example, as in a/dev/random file in Linux, input information from a keyboard or a mouse to a computer system is pooled, and retrieved and used as a seed as needed. However, this method may require time to obtain a necessary quantity of random numbers, and is not easy to use in a system such as a server system having a low frequency of input from outside.

In contrast to a pseudo-random number, physical random number generators generate physical random numbers which are unpredictable because the physical random numbers do not have regularity and repeatability. These physical random number generators are being used in statistics, financial simulation, large-scale physical simulation, security and other fields. Physical random numbers are a number sequence generated using a natural phenomenon in which numbers are randomly arranged. For example, Japanese Patent Application Laid-Open Publication No. 2007-304730 discloses a physical random number generator which generates physical random numbers by applying high-speed digital processing to random thermionic signals inside a semiconductor device.

Although physical random numbers are unpredictable high-quality random numbers since the physical random numbers use a natural phenomenon, physical random number generators require dedicated hardware such as a temperature sensor. Accordingly, the physical random number generators become complicated and larger, and are not easy to use in a small-scale system.

### BRIEF SUMMARY OF THE INVENTION

A random number generator of an embodiment of the present invention includes: a bus including a plurality of bus lines configured to send and receive a signal between circuits; a calibration unit configured to dynamically adjust a reception condition of the signal; and a random number generating unit configured to generate a random number based on adjustment information of the calibration unit.

A pseudo-random number generator of another embodiment of the present invention includes: a bus including a plurality of bus lines configured to send and receive a signal between circuits; a calibration unit configured to dynamically adjust a reception condition of the signal; a random number generating unit configured to generate a random number based on adjustment information of the calibration unit; and a pseudo-random number generating unit configured to generate a pseudo-random number wherein the random number generated by the random number generating unit is a seed.

A random number generator of another embodiment of the present invention includes: a CPU; an auxiliary operation device having a calibration unit configured to dynamically adjust a reception timing of a signal between the CPU and the auxiliary operation device; a bus including a plurality of bus lines configured to send and receive the signal; a calibration information converting unit configured to generate one-bit data of “1” if a variation of the reception timing increases and to generate one-bit data of “0” if a variation of the reception timing decreases; and a random number generating unit which includes a memory unit configured to sequentially store one-bit data generated by the calibration information converting unit, a sampling unit configured to perform sampling processing to sequentially sample the one-bit data stored in the memory unit and obtain a number sequence of a bit length of a random number to be generated, and a shifting unit configured to apply rotational shift processing to the number sequence for each of the sampling processes of the sampling unit and generate the random number.

### BRIEF DESCRIPTION OF THE DRAWINGS

FIG. 1 is a configuration diagram showing a schematic configuration of a random number generator of a first embodiment;

FIG. 2 is a flowchart illustrating a flow of operation of the random number generator of the first embodiment;

FIG. 3 is an explanatory diagram illustrating processing of the random number generator of the first embodiment;

FIG. 4 is a flowchart illustrating a flow of operation of a random number generator of a second embodiment;

FIG. 5 is an explanatory diagram illustrating processing of the random number generator of the second embodiment;

FIG. 6 is a configuration diagram showing a schematic configuration of a random number generator of a third embodiment;

FIG. 7 is a flowchart illustrating a flow of operation of the random number generator of the third embodiment; and

FIG. 8 is an explanatory diagram illustrating processing of the random number generator of the third embodiment.

### DETAILED DESCRIPTION OF THE INVENTION

### First Embodiment

Hereinafter, a random number generator 1 of the first embodiment of the present invention will be described with reference to the drawings.

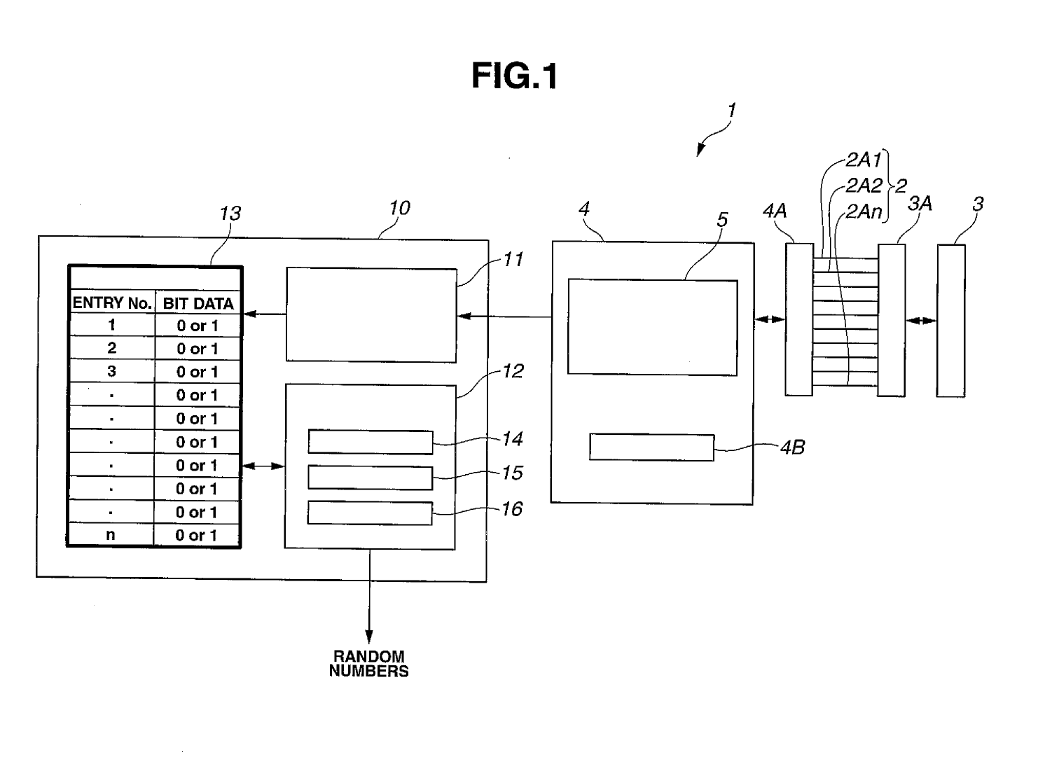

As shown in FIG. 1, the random number generator 1 of the present embodiment has a bus 2 including n bus lines 2A1 to 2An configured to send and receive a signal between a circuit 3 that is a first circuit and a circuit 4 that is a second circuit through an interface 3A and an interface 4A, a calibration unit 5 configured to dynamically adjust a reception timing which is a reception condition for the circuit 4 to receive the signal, and a random number generating unit 10 configured to generate a random number based on adjustment information of the calibration unit 5. It is assumed here that n=10 as an example. The calibration unit 5 performs first calibration at system initialization, and furthermore repeats calibration dynamically during an operating time of the system. The circuit 3 is a CPU and the circuit 4 is an auxiliary operation device fabricated on the same chip as the CPU, for example. The circuit 4 and the circuit 10 may be installed on the circuit 3 side.

A timing of sending and receiving of a signal via a bus line is determined based on, for example, a clock signal generated by a clock unit 4B provided in the circuit 4. However, a delay time in which a clock signal generated by the clock unit 4B reaches the circuit 3, the circuit 3 sends the signal, and the circuit 4 receives the signal, varies depending on a condition of a surrounding environment such as a temperature. Variation amount of the delay time differs for each bus line. Therefore, calibration is indispensable, which adjusts a phase of the clock signal generated by the clock unit 4B and optimizes a reception timing that is a reception condition for the circuit 4 to receive the signal and the like. The calibration is performed by the calibration unit 5.

The calibration unit 5 performs calibration processing for each bus line, dynamically, that is, for each unit time. For example, in a case of buses operating at an operating frequency of several tens of MHz, calibration is performed several tens of million times per second for every bus line. As previously described, temperature is a factor which most influences a calibration condition.

As shown in FIG. 1, the random number generator 1 of the present embodiment has a calibration information converting unit 11 configured to generate one-bit data 1 of “0” or “1” based on a variation of a reception timing of each bus line 2A, which is adjustment information adjusted by the calibration unit 5, a memory unit 13 which has a Least Recently Used type table configured to sequentially store one-bit data generated by the calibration information converting unit 11, a sampling unit 14 configured to perform sampling processing to sequentially sample the one-bit data stored in the memory unit 13 and obtain a number sequence of a predetermined bit length, e.g., 8-bit length, a counting unit 16 configured to count the number of random number generation, a shifting unit 15 configured to rotationally shift the number sequence of the predetermined bit length based on information of the counting unit 16 and generate the random number. The memory unit 13 is an LRU (Least Recently Used) memory unit.

The number of the bus lines n just needs to be greater than or equal to a bit length of generated random numbers, and not all the bus lines' adjustment information is required to be used. The number of bus lines to be used for random number generation is assumed to be ten as an example for simplicity in the following description.

The bus 2 configured to send and receive a signal between the circuit 3 and the circuit 4 and the calibration unit 5 are components important for the random number generator 1 of the present invention as described above, but original purposes of the bus 2 and the calibration unit 5 are different from it while the bus 2 and the calibration unit 5 are the components used also by the random number generator 1.

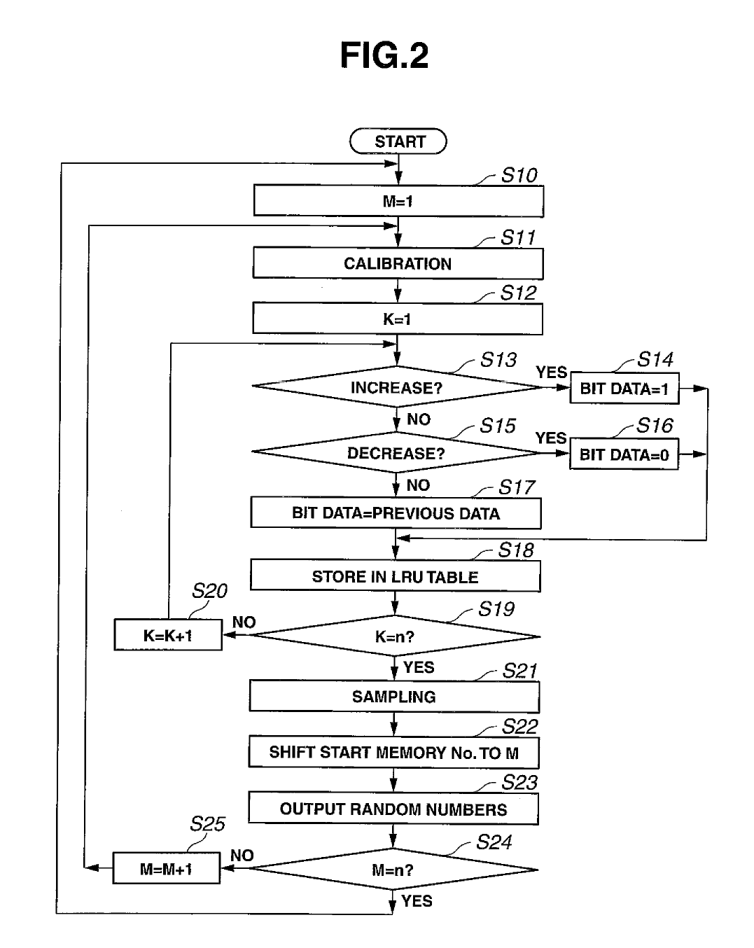

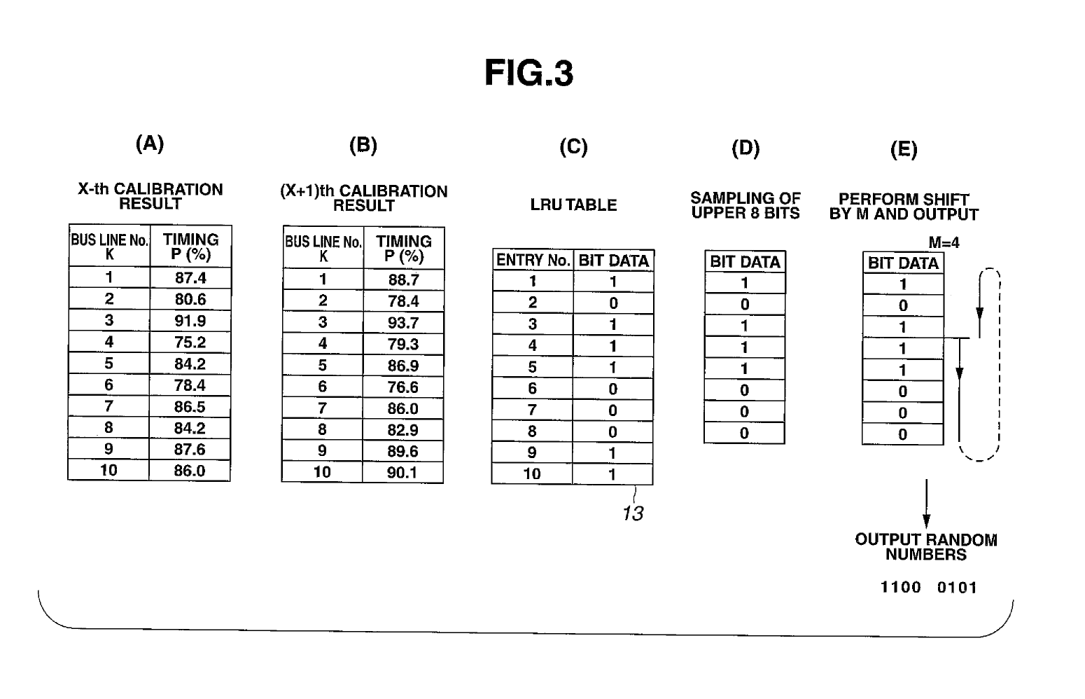

Next, a flow of operation of the random number generator 1 of the present embodiment will be described using FIGS. 2 and 3. A description will be made below with reference to the flowchart of FIG. 2.

### <Step S10> Initialization of a Counter M

First, the counter M of the counting unit 16 configured to count the number of random number generation is initialized to “1”.

### <Step S11> Calibration

The calibration unit 5 performs calibration processing with respect to each of n bus lines to adjust a reception state to an optimum state. FIG. 3(A) shows adjustment information which is an optimized timing. This illustrates an example in which a clock at a best timing (a state of a complete leading edge or trailing edge of a signal) is normalized to 100% and a clock at a worst timing (a state where a signal makes no sense) is normalized to 0%.

### <Step S12> Initialization of a Counter K

The counter K of the counting unit 16 is initialized to “1” in order to sequentially process adjustment information of calibration of the n bus lines. Loops for a loop variable K may be processed in parallel, that is, simultaneously at each bus line.

### <Step S13, Step S14, Step S18> Calibration Information Conversion 1

As shown in FIG. 3(C), if a timing of adjustment information of calibration of a bus line whose bus line number is K is increased compared to previous adjustment information (bus lines No. 1, 3, 4, etc.), the calibration information converting unit 11 outputs “1” at entry No. K of the Least Recently Used type table (LRU table) of the memory unit 13. At this time, data stored at entry No. K is erased.

### <Step S15, Step S16, Step S18> Calibration Information Conversion 2

As shown in FIG. 3(C), if a timing of adjustment information of calibration of a bus line whose bus line number is K is decreased compared to previous adjustment information (bus lines No. 2, 6, 7, etc.), the calibration information converting unit 11 outputs “0” at entry No. K of the Least Recently Used type table of the memory unit 13.

### <Step S17, Step S18> Calibration Information Conversion 3

If a timing of adjustment information of calibration of a bus line whose bus line number is K is the same as a timing of previous adjustment information, the calibration information converting unit 11 outputs the same value as in a previous time at entry No. K of the memory unit 13.

### <Step S19, Step S20> Processing of N Bus Lines

The calibration information converting unit 11 continues processing until the counter K becomes the number of bus lines N, e.g., 10.

### <Step S21> Sampling

As shown in FIG. 3(D), the sampling unit 14 samples a number sequence of a predetermined number of upper bits, e.g., 8 bits from an n-bit data sequence stored in the memory unit 13.

Although the number sequence obtained in step S21 is random numbers, the random number generator 1 of the present embodiment performs processing from step S22 in order to generate higher-quality random numbers.

### <Step S22> Rotational Shift

The shifting unit 15 performs rotational shift processing to rotationally shift the n-bit length data sequence sampled by the sampling unit 14 by a value of the counter M of the counting unit 16.

As used herein, rotational shift processing refers to processing for making one-bit data in a predetermined position most significant and changing other data positions in turn as shown in FIG. 3(E). FIG. 3(E) shows a case where M=4, and shifting is performed such that a fourth bit of the sampled 8-bit length data sequence is set as a most significant bit.

### <Step S23> Output of Random Numbers

A random number generating unit 12 outputs the 8-bit length data sequence rotationally shift-processed by the shifting unit 15, as random numbers.

### <Step S24, Step S25> Continuation of Output of Random Numbers

The shifting unit 15 increases the value M for rotational shift one by one so that output of random numbers is continuously performed. When M becomes the data length n, M is initialized to 1 again.

As described above, the random number generator 1 of the present embodiment generates random numbers based on calibration information of the calibration unit 5 which has been provided in the circuit 3 and the circuit 4 for a different purpose, and therefore has a simple configuration. In other words, the circuit 3 that is the first circuit and the circuit 4 that is the second circuit are circuits indispensable to the random number generator 1, but are not circuits dedicated to the random number generator 1.

Even though the random number generator 1 has the simple configuration, the random number generator 1 can generate random numbers fast and constantly. Further, a random number generated by the random number generator 1 is an unpredictable physical random number because a timing of calibration is dependent on temperature. Thus, the random number generator 1 can generate high-quality random numbers with the simple configuration.

Although the random number generator 1 which generates random numbers based on calibration information of the bus 2 having ten bus lines 2A has been described above for simplicity of description, the number of bus lines may be greater than or equal to 100, for example, 144 in a given CPU, and the random number generator of the present invention using calibration of this CPU's bus may generate random numbers having a longer data length which is 64 bit length or 128 bit length. The random number generator 1 does not need to use information of all the bus lines 2A.

Although a timing is used as an example of an object of calibration in the above description, various information such as a current value or a capacity may be used to be dynamically calibrated.

Although in the above description the calibration information converting unit 11 sets bit data to “1” if a timing is increased, and sets bit data to “0” if the timing is decreased, bit data may be set to “0” if the timing is increased and bit data may be set to “1” if the timing is decreased, or bit data may be replaced only when there is increase or decrease at a predetermined rate or more.

### Second Embodiment

Hereinafter, a random number generator of a second embodiment will be described with reference to the drawings. Because the random number generator of the second embodiment of the present invention is similar to the random number generator 1 of the first embodiment, the same components are given the same reference numerals, and the same description will be omitted.

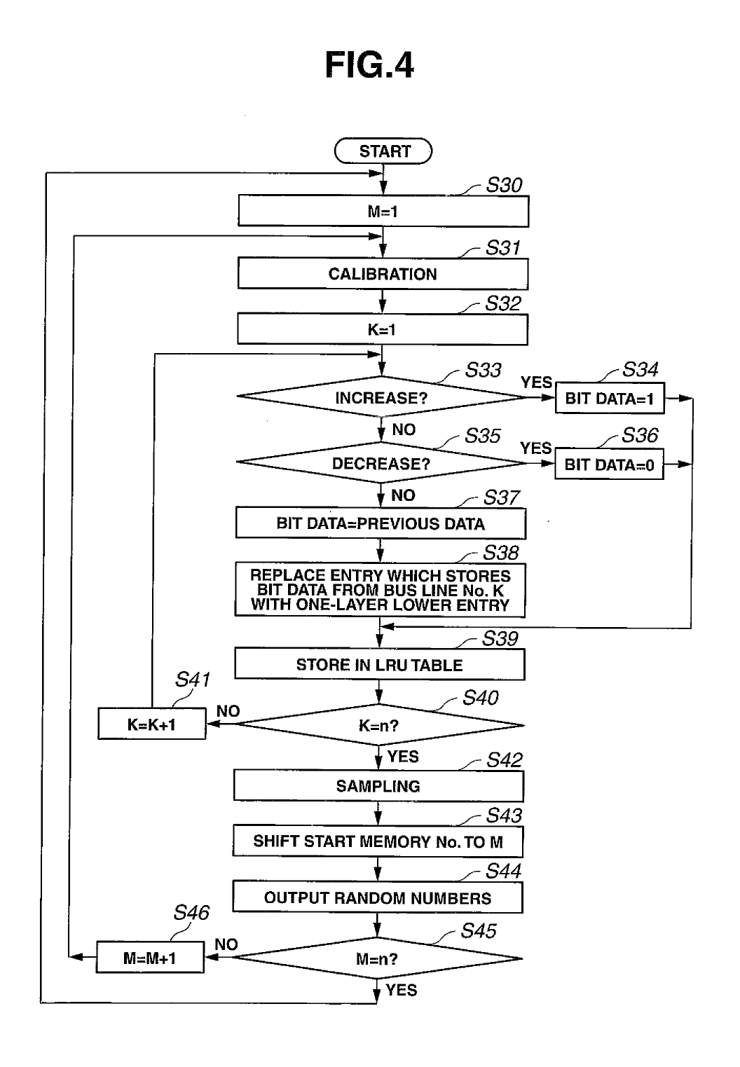

A description will be made below with reference to the flowchart of FIG. 4.

### <Steps S30 to S37>

Steps S30 to S37 are the same as the already described steps S10 to S17, and a description thereof will be omitted.

### <Step S38> Replacement of Entries

In the random number generator of the present embodiment, the calibration information converting unit 11 replaces an entry number of the memory unit 13 for storing one-bit data based on a bus line 2A whose adjustment information is the same as previous adjustment information, with a one-layer lower entry number.

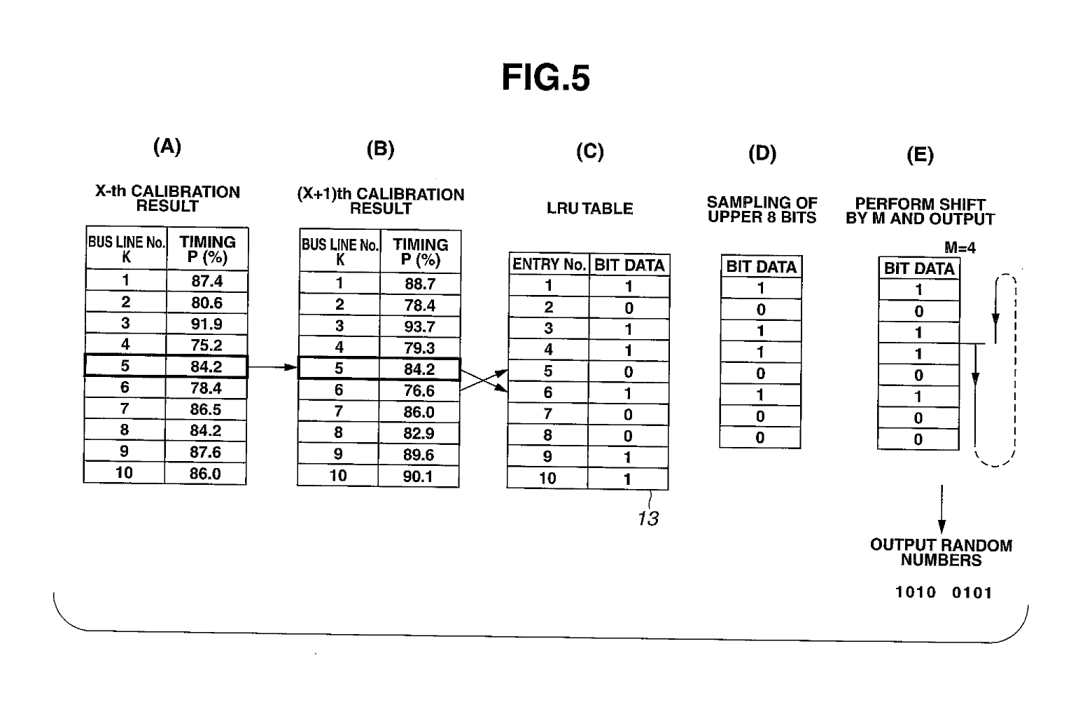

As shown in FIG. 5 and other figures, in some states, one-bit data based on information of bus lines No. 1 to 10 are sequentially recorded in entries of a Least Recently Used type table of memory unit 13 in an order of bus line numbers from a top. However, as shown in FIGS. 5(A) and 5(B), for example, a timing of bus line No. K=5 is 84.2% at an X-th result, and is also 84.2% at an (X+1)th result. In this case, the calibration information converting unit 11 of the present embodiment makes a change so that one-bit data based on information of the bus line No. K=5 is stored at entry No. 6 of the memory unit 13, and one-bit data based on information of bus line No. K=6 is stored at entry No. 5 of the memory unit 13. Then, this change is kept even in and after next generation of random numbers. Accordingly, an entry position of one-bit data based on information of a bus line 2A whose reception timing is less likely to vary is gradually lowered on the table of the memory unit 13 by repetitive processing.

Although each bus line 2A has its respective characteristic, and one-bit data based on adjustment information of calibration of a bus line 2A which is less likely to vary is less likely to vary, the random number generator of the second embodiment can prevent fixing of a bit. Specifically, an entry number of the memory unit 13 of data from such a bus line is changed to a lower-level entry number so that, in a case where the number of bit sampled by the sampling unit 14 is smaller than the number of data entered in the table, one-bit data based on adjustment information of a bus line 2A which is less likely to vary is not entered in sampled upper bits. In other words, data from a bus line at which a frequency of change of a timing before and after calibration is low is removed as much as possible, so that a more random number sequence can be generated.

### <Steps S39 to S46>

Steps S39 to S46 are the same as the already described steps S18 to S25 of FIG. 2, and a description thereof will be omitted.

In addition to an advantage of the random number generator 1 of the first embodiment, the random number generator of the present embodiment can generate a higher-quality random number.

### Third Embodiment

Hereinafter, a pseudo-random number generator 101 of a third embodiment of the present invention will be described with reference to the drawings. Because the pseudo-random number generator 101 of the third embodiment of the present invention is similar to the random number generator 1 of the first embodiment, the same components are given the same reference numerals, and the same description will be omitted.

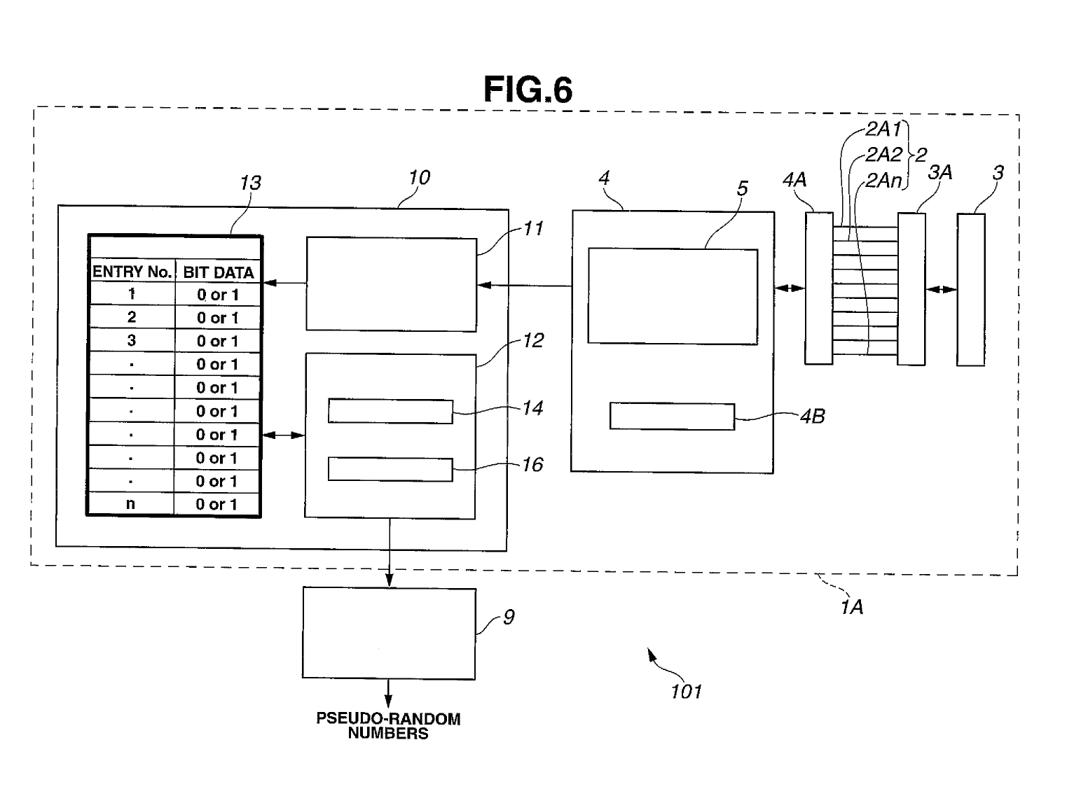

As shown in FIG. 6, the pseudo-random number generator 101 of the present embodiment has a random number generator 1A, and a pseudo-random number generating unit 9 configured to generate a pseudo-random number using the random number generated by the random number generator 1A as a seed. Although a random number generated by the random number generator 1 is a physical random number and thus unpredictable, the pseudo-random number generator 101 performs processing by the pseudo-random number generating unit 9 in order to obtain a higher-quality random number by a simpler configuration.

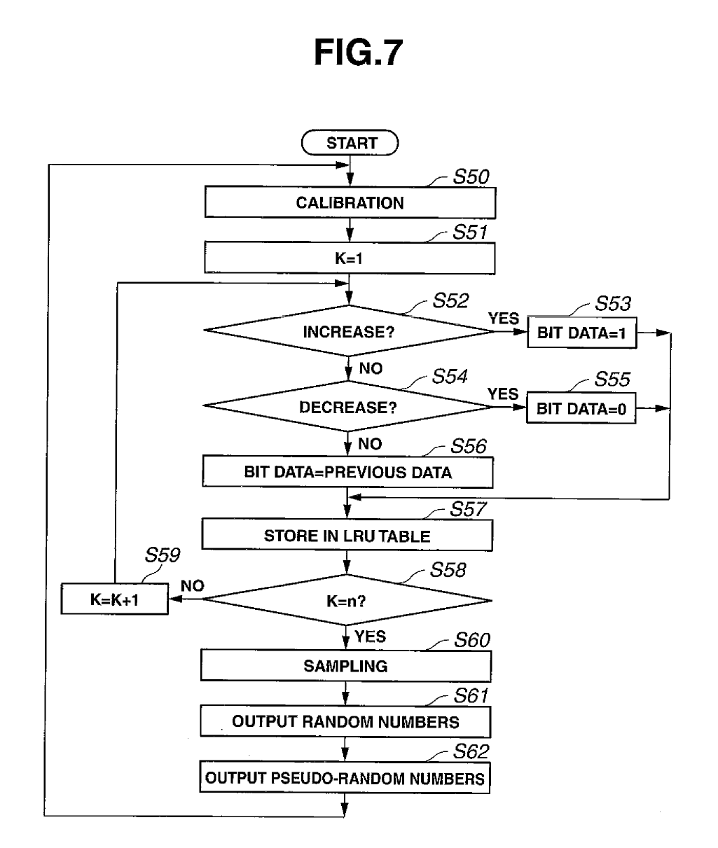

Processing of the pseudo-random number generator 101 will be described below with reference to a flowchart of FIG. 7.

### <Steps S50 to S60>

Steps S50 to S60 are the same as the already described steps S11 to S21, and a description thereof will be omitted.

### <Step S61> Output of Random Numbers

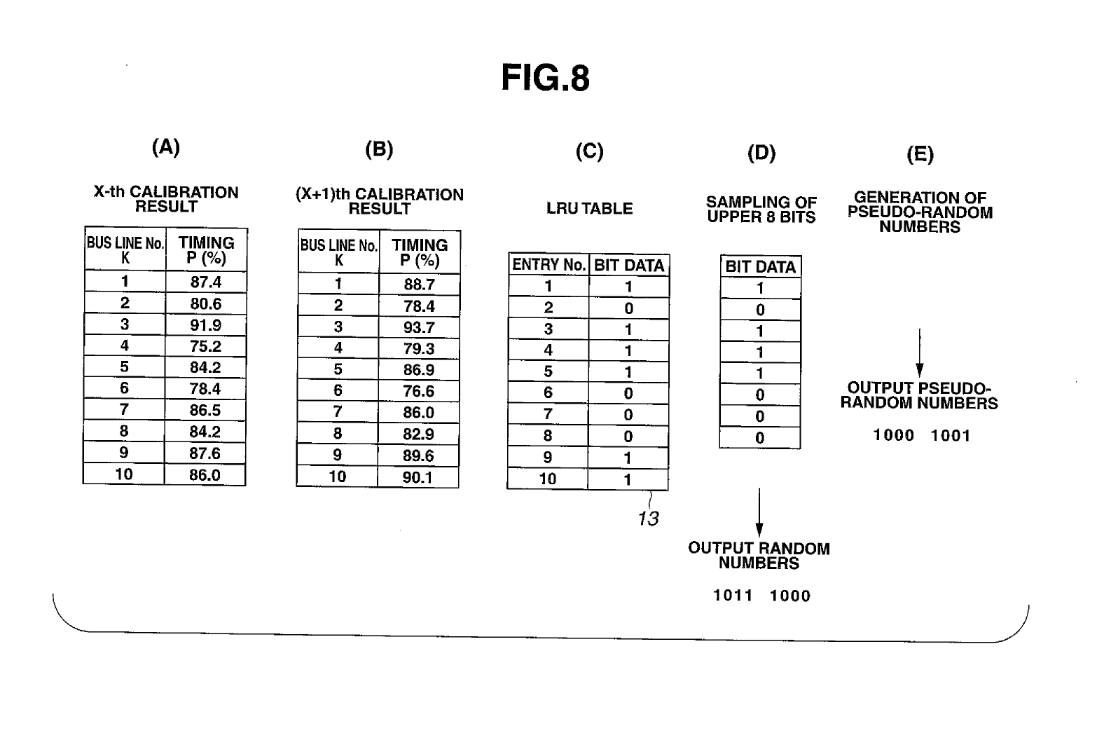

As shown in FIG. 8(D), the random number generator 1A outputs upper bits of a predetermined bit length sampled by the sampling unit 14 from an LRU table in which the number of entries is greater than or equal to eight, as random numbers to the pseudo-random number generating unit 9. The upper bits are a sequence of data which were entered relatively earlier and are, for example, upper 8 bits. Thus, unlike the random number generator 1 and so on, the random number generator 1A does not perform rotational shift processing, processing for changing an entry number on the memory unit 13, and the like. Therefore, the random number generator 1A has a simpler configuration than the configuration of the random number generator 1.

### <Step S62> Output of Pseudo-Random Numbers

The pseudo-random number generating unit 9 generates a pseudo-random number using the random number outputted from the random number generator 1A as a seed.

As described above, the pseudo-random number generator 101 uses a result of calibration of a calibration unit in a system having the calibration unit for preventing influence of heat and voltage, so that the pseudo-random number generator 101 can acquire a seed for pseudo-random number generation which reflects randomness of heat, voltage, and the like at low cost and high speed.

In other words, a pseudo-random number generated by the pseudo-random number generating unit 9 of the pseudo-random number generator 101 is high-quality because a seed of the pseudo-random number is a random number. Further, the pseudo-random number generating unit 9 is easy to build because the configuration of the random number generator 1A is simpler than the configuration of the random number generator 1. In addition, it will be appreciated that, in order to generate a higher-quality pseudo-random number, the random number generator 1 of the first embodiment or the random number generator of the second embodiment may be provided to the pseudo-random number generator of the third embodiment.

In program code of an operating system, a device driver, and a user application, when a certain program execution unit (a process, a thread, or the like) performs processing for acquiring a value of a random number or a pseudo-random number's seed from a random number generating device in a multithread, multiprocessor or other parallel execution environment, exclusive processing is preferably performed during a period longer than or equal to a cycle of execution of each calibration so as to prevent other program execution units from performing value acquisition processing. In other words, it is preferably ensured that adjustment information of one calibration can be acquired only by one program execution unit. The above configuration can exclude a possibility that, at the same instant when one software attempts to use a generated number sequence, another software reads the same number sequence. This is effective especially in software related to security.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A random number generator comprising:
a bus including a plurality of bus lines configured to send and receive a signal between circuits;
a calibration unit configured to dynamically adjust a reception condition of the signal; and
a random number generating unit configured to generate a random number based on adjustment information of the calibration unit.

2. The random number generator according to claim 1,
wherein the reception condition adjusted by the calibration unit is a reception timing, and
the random number generating unit has a calibration information converting unit configured to generate one-bit data of “0” or “1” based on a variation of the reception timing of each of the bus lines.

3. The random number generator according to claim 2, wherein the random number generating unit comprises:
a memory unit which has a Least Recently Used type table configured to sequentially store, in a predetermined rank of entry, one-bit data generated by the calibration information converting unit;
a sampling unit configured to perform sampling processing to sequentially sample the one-bit data stored in the memory unit and obtain a number sequence of a bit length of the random number; and
a shifting unit configured to apply rotational shift processing to the number sequence for each of the sampling processes of the sampling unit and generate the random number.

4. The random number generator according to claim 3, wherein if the reception timing of the bus line has not varied, the calibration information converting unit reduces the rank of entry for storing the one-bit data based on the bus line in the memory unit.

5. The random number generator according to claim 4, wherein the bus sends and receives a signal between a CPU and an auxiliary operation device fabricated on a same chip as the CPU.

6. The random number generator according to claim 4, wherein the calibration information converting unit generates one-bit data of “1” if the variation of the reception timing increases, and generates one-bit data of “0” if the variation of the reception timing decreases.

7. The random number generator according to claim 5, wherein the memory unit updates the bit data only when there is increase or decrease of the variation of the reception timing at a predetermined rate or more.

8. The random number generator according to claim 6, wherein the reception timing varies depending on temperature.

9. A pseudo-random number generator comprising:
a bus including a plurality of bus lines configured to send and receive a signal between circuits;
a calibration unit configured to dynamically adjust a reception condition of the signal;
a random number generating unit configured to generate a random number based on adjustment information of the calibration unit; and
a pseudo-random number generating unit configured to generate a pseudo-random number wherein the random number generated by the random number generating unit is a seed.

10. The pseudo-random number generator according to claim 9,
wherein the reception condition adjusted by the calibration unit is a reception timing, and
the random number generating unit has a calibration information converting unit configured to generate one-bit data of “0” or “1” based on a variation of the reception timing of each of the bus lines.

11. The pseudo-random number generator according to claim 10, wherein the random number generating unit comprises:
a memory unit which has a Least Recently Used type table configured to sequentially store, in a predetermined rank of entry, one-bit data generated by the calibration information converting unit;
a sampling unit configured to perform sampling processing to sequentially sample the one-bit data stored in the memory unit and obtain a number sequence of a bit length of the random number; and
a shifting unit configured to apply rotational shift processing to the number sequence for each of the sampling processes of the sampling unit and generate the random number.

12. The pseudo-random number generator according to claim 11, wherein if the reception timing of the bus line has not varied, the calibration information converting unit reduces the rank of entry for storing the one-bit data based on the bus line in the memory unit.

13. The pseudo-random number generator according to claim 12, wherein the bus sends and receives a signal between a CPU and an auxiliary operation device fabricated on a same chip as the CPU.

14. The pseudo-random number generator according to claim 13, wherein the calibration information converting unit generates one-bit data of “1” if the variation of the reception timing increases, and generates one-bit data of “0” if the variation of the reception timing decreases.

15. The pseudo-random number generator according to claim 14, wherein the memory unit updates the bit data only when there is increase or decrease of the variation of the reception timing at a predetermined rate or more.

16. The pseudo-random number generator according to claim 15, wherein the reception timing varies depending on temperature.

17. A random number generator comprising:
a CPU;
an auxiliary operation device having a calibration unit configured to dynamically adjust a reception timing of a signal between the CPU and the auxiliary operation device;
a bus including a plurality of bus lines configured to send and receive the signal;
a calibration information converting unit configured to generate one-bit data of “1” if a variation of the reception timing increases and to generate one-bit data of “0” if a variation of the reception timing decreases; and
a random number generating unit which includes a memory unit having a Least Recently Used type table configured to sequentially store, in a predetermined rank of entry, one-bit data generated by the calibration information converting unit, a sampling unit configured to perform sampling processing to sequentially sample the one-bit data stored in the memory unit and obtain a number sequence of a bit length of a random number to be generated, and a shifting unit configured to apply rotational shift processing to the number sequence for each of the sampling processes of the sampling unit and generate the random number.
